(19) United States
(12) Patent Application Publication
(10) Pub. No.: US 2008/0138712 A1
(43) Pub. Date: Jun. 12, 2008

(54) FILTER MEDIUM AND FILTRATION SYSTEM UTILIZING THE SAME

(75) Inventor: Koji SUZUKI, Hamamatsu (JP)

Correspondence Address: YOUNG & THOMPSON, 209 Madison Street, Suite 500, ALEXANDRIA, VA, 22314, US

(73) Assignee: TOYO ROKI SEIZO KABUSHIKI KAISHA, Hamamatsu (JP)

(21) Appl. No.: 11/940,337

(22) Filed: Nov. 15, 2007

(30) Foreign Application Priority Data
Dec. 7, 2006 (JP) 2006-330482

(51) Int. Cl. H01M 2/16; B01D 39/20

(52) U.S. Cl. 429/247; 210/496

(57) ABSTRACT

A filter medium includes a ceramic mass having a void formed by burning a contained carbon to be eliminated. The ceramic mass has an inflow side for a fluid to flow thereinto and an outflow side for the fluid to flow out therefrom. The inflow side and the outflow side separate from each other with a distance. The inflow side and the outflow side have holes depressed inward from the sides, respectively.

### CROSS-REFERENCE TO RELATED APPLICATIONS

This application is based upon and claims the benefit of priority from Japanese Patent Application No. 2006-330482 filed on Dec. 7, 2006; the entire contents of which are incorporated herein by reference.

### BACKGROUND OF THE INVENTION

The invention relates to a filter medium for filtering a fluid flowing in a fluid path connected to a fuel cell and a filtration system utilizing the filter medium.

Various devices employing energy sources instead of fossil fuels have been developed recently. Techniques for using fuel cells as driving sources have been developed increasingly. In the field of vehicles using internal combustion engines such as automobiles, vehicles using fuel cells instead of such internal combustion engines have been being developed.

The fuel cell has fluid paths connected thereto such as circuits for feeding hydrogen which is a reducing material serving as a fuel and oxygen which is an oxidizing material and a cooling circuit for preventing increases in temperature on the fuel cell stack. Methods for filtering such fluids flowing in the fluid paths have been studied.

The present applicant has disclosed an ion exchange filter for preventing ionization of pure water flowing in a pure water humidifying circuit and cooling water flowing in a cooling circuit in the fuel cell (Japanese Patent Application Laid-open No. 2005-166267).

Meanwhile, as in Japanese Patent Application Laid-Open No. 2003-269131, for example, filters made of ceramic are provided in emission systems for automobile engines to remove particles from emissions.

According to the fluid path connected to the fuel cell, an air feeding circuit is connected to a compressor while a circulation circuit in a cooling device to a pump for circulating cooling water. Such devices may produce impurities such as fine abrasion powders during their operations. The previous studies on the fuel cell do not recognize such impurities produced from the devices. Therefore, any measures have not been taken for removing the impurities. The fluid path connected to the fuel cell has relatively high temperatures. Filter paper and non-woven fabric commonly utilized for a filter medium have low heat-resistance, being not suitable for the filtration system of the fuel cell.

When ceramic is employed for the filter medium, it is effective for systems to be filtered with high temperatures.

However, ceramic is brittle. If ceramic is employed for the filter medium and the resulting ceramic filter medium is utilized in vibrating systems, ceramic powders may spill or the filter medium may be chipped. Extremely high purity is required in the fluid path of the fuel cell. Ceramic is difficult to be employed for the filter medium in fluid paths for fuel cells mounted in vibrating automobiles.

To solve the problem, ceramic powders may be compacted using binders. However, fluids may be contaminated by dissolution of such binders.

### SUMMARY OF THE INVENTION

The invention is directed to a filter medium using a ceramic mass having excellent heat- and vibration-resistances without dissolution of a binder.

The invention is directed to a filtration system that filters a fluid in a fluid path connected to a fuel cell by using the filter medium to maintain high purity.

The first aspect of the invention provides a filter medium. The filter medium includes a ceramic mass having a void formed by burning a contained carbon to be eliminated. The ceramic mass has an inflow side for a fluid to flow thereinto and an outflow side for the fluid to flow out therefrom. The inflow side and the outflow side separate from each other with a distance. The inflow side and the outflow side have holes depressed inward from the sides, respectively.

The second aspect of the invention provides a filter medium. The filter medium includes a ceramic mass having a void formed by burning a contained carbon to be eliminated. The ceramic mass has an inflow side for a fluid to flow thereinto and an outflow side for the fluid to flow out therefrom. The inflow side and the outflow side separate from each other with a distance. The ceramic mass has a surface having a circumferential surface between the inflow side and the outflow side. At least the circumferential surface is coated with a coating material.

The third aspect of the invention provides a filter medium. The filter medium includes a ceramic mass having a void formed by burning a contained carbon to be eliminated. The ceramic mass has an inflow side for a fluid to flow thereinto and an outflow side for the fluid to flow out therefrom. The inflow side and the outflow side separate from each other with a distance. The ceramic mass has a surface having a circumferential surface between the inflow side and the outflow side. At least the circumferential surface is coated with a coating material. The inflow side and the outflow side have holes depressed inward from the sides, respectively.

The ceramic mass may have an entire surface coated with a coating material. The coating material may have communication holes coinciding with the holes of the inflow side and the outflow side. The communication holes may extend through the coating material in a thickness direction of the coating material and communicate with outside of the ceramic mass.

The fourth aspect of the invention provides a filtration system installed in a fluid path connected to a fuel cell for filtrating a fluid circulating through the fluid path by a filtration device. The filtration device has a ceramic mass having a void formed by burning a contained carbon to be eliminated. The ceramic mass has an inflow side for a fluid to flow thereinto and an outflow side for the fluid to flow out therefrom. The inflow side and the outflow side separate from each other with a distance. The inflow side and the outflow side have holes depressed inward from the sides, respectively. The filtration device is located downstream of a flow driver allowing the fluid to circulate through the fluid path.

The fifth aspect of the invention provides a filtration system installed in a fluid path connected to a fuel cell for filtrating a fluid circulating through the fluid path by a filtration device. The filtration device has a ceramic mass having a void formed by burning a contained carbon to be eliminated. The ceramic mass has an inflow side for a fluid to flow thereinto and an outflow side for the fluid to flow out therefrom. The inflow side and the outflow side separate from each other with a distance. The ceramic mass has a surface having a circumferential surface between the inflow side and the outflow side. At least the circumferential surface is coated with a coating material. The filtration device is located downstream of a flow driver allowing the fluid to circulate through the fluid path.

The sixth aspect of the invention provides a filtration system installed in a fluid path connected to a fuel cell for filtrating a fluid circulating through the fluid path by a filtration device. The filtration device has a ceramic mass having a void formed by burning a contained carbon to be eliminated. The ceramic mass has an inflow side for a fluid to flow thereinto and an outflow side for the fluid to flow out therefrom. The inflow side and the outflow side separate from each other with a distance. The ceramic mass has a surface having a circumferential surface between the inflow side and the outflow side. At least the circumferential surface is coated with a coating material. The inflow side and the outflow side have holes depressed inward from the sides, respectively. The filtration device is located downstream of a flow driver allowing the fluid to circulate through the fluid path.

The ceramic mass may have an entire surface coated with a coating material. The coating material may have communication holes coinciding with the holes of the inflow side and the outflow side. The communication holes may extend through the coating material in a thickness direction of the coating material and communicate with outside of the ceramic mass.

### BRIEF DESCRIPTION OF THE ACCOMPANYING DRAWINGS

FIG. 1 is a schematic diagram of a circuit system for a fuel cell in a filtration system according to an embodiment of the invention;

FIG. 2 is a vertical cross-sectional view of a schematic internal structure of the filter illustrated in FIG. 1;

FIG. 3 is a perspective view of the ceramic filter illustrated in FIG. 2;

FIG. 4 is a vertical cross-sectional view of a schematic structure of the ceramic filter illustrated in FIG. 3;

FIG. 5 is a vertical cross-sectional view of a schematic structure of a ceramic filter different from that of FIG. 4;

FIG. 6 is a vertical cross-sectional view of a schematic structure of a ceramic filter different from that of FIGS. 3 to 5; and

FIG. 7 is a vertical cross-sectional view of a schematic structure of a ceramic filter different from that of FIG. 6.

### DETAILED DESCRIPTION OF THE PREFERRED EMBODIMENTS

Embodiments of the invention will be described below with reference to the accompanying drawings

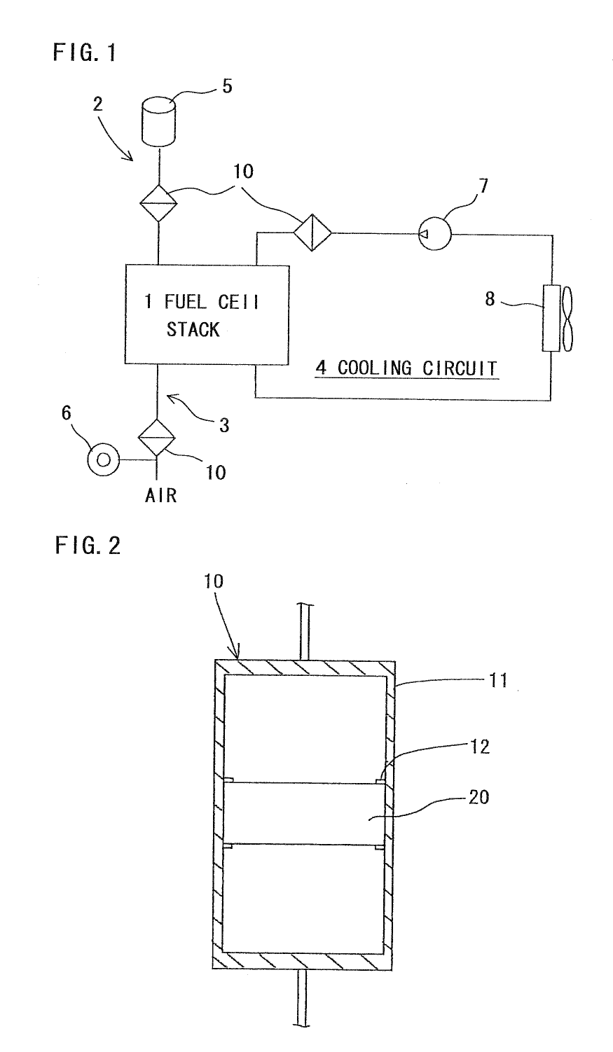

FIG. 1 is a schematic view of a fuel cell system that utilizes a ceramic filter 20 which is a filter medium of the invention and a filtration system. A fuel cell stack 1 is connected to a hydrogen feeding circuit 2 for feeding hydrogen to the fuel cell stack 1, an aspiration circuit 3 for feeding air from the atmosphere, and a cooling circuit 4 for cooling the fuel cell stack 1.

The hydrogen feeding circuit 2 has a hydrogen tank 5 that stores hydrogen serving as a fuel for the fuel cell. The hydrogen feeding circuit 2 also has a pipe connecting the hydrogen tank 5 to the fuel cell stack 1. The hydrogen tank 5 contains a high pressure hydrogen filled therein. The filled hydrogen is reduced in pressure by a reducing valve to be fed to the fuel cell stack 1.

The aspiration circuit 3 has a pipe connecting the atmosphere to the fuel cell stack 1. The pipe has a compressor 6 serving as a flow driver that pressurizes air for allowing the pressurized air to flow to the fuel cell stack 1. In the aspiration circuit 3, the filter 10 is connected to the downstream side of the compressor 6. The filter 10 filters impurities contained in the circuit.

The cooling circuit 4 is a closed circulating circuit. The cooling circuit 4 has a pump 7 serving as a flow driver for circulating cooling water in the cooling circuit 4. The cooling circuit 4 also has a radiator 8 for cooling the circulating cooling water. The cooling circuit 4 has the filter 10 on the downstream side of the pump 7 and the upstream side of the fuel cell stack 1. The filter 10 filters impurities contained in the cooling water circulating in the circuit. In addition to ordinary water, the cooking water employs a mixed solution of ethylene glycol and water having an anti-freezing property in consideration of utilizing the fuel cell system in cold climates.

When fluids flowing in the hydrogen feeding circuit 2, aspiration circuit 3, and cooling circuit 4 are filtered, the following points should be considered.

The hydrogen feeding circuit 2 will be described first. The hydrogen feeding circuit 2 has the pipe connecting the hydrogen tank 5 to the fuel cell stack 1. The pipe does not have any portions communicating with the atmosphere. Dust thus does not enter the hydrogen feeding circuit 2 from the atmosphere during its normal operation. Fine impurities may remain in the hydrogen tank 5. Impurities may enter the hydrogen feeding circuit 2 when hydrogen is refilled in the hydrogen tank 5 or the hydrogen tank 5 is replaced. The hydrogen feeding circuit 2 feeds hydrogen which is a fuel for the fuel cell, removing impurities for feeding hydrogen with high purity. Impurities thus should be removed reliably from the hydrogen feeding circuit 2. Specifically, impurities of larger than 1 μm should be removed reliably. Finer impurities by the 0.1 μm may be removed. A filter medium capable of filtering such impurities is selected and provided in the filter 10. The hydrogen feeding circuit 2 is for feeding hydrogen, and filters made of metals may be broken due to hydrogen brittleness. When the filter 10 is provided in the hydrogen feeding circuit 2, the filter medium is made of materials that do not cause the hydrogen brittleness.

The aspiration circuit 3 aspirates air from the atmosphere. The atmosphere contains various impurities, and it cannot be employed as a fuel for the fuel cell unless the impurities are removed. An oxygen contained in the atmosphere is also employed as a fuel for the fuel cell, and impurities larger than 1 μm should be removed reliably. A filter medium capable of removing finer impurities by the 0.1 μm may be provided in the filter 10. The temperature of the aspiration circuit 3 is increased to about 160° C. A filter medium made of heat-resistance materials withstanding high temperatures is employed.

The cooling circuit 4 will be described next. The cooling circuit 4 is a closed circuit, and impurities do not enter the circuit 4 from the outside. Components of the pump 7 wear out according to the operation of the pump 7, thus producing abrasion powder. The filter 10 removes such abrasion powder from the cooling water to feed the resulting filtered water to the fuel cell stack 1.

The temperature of the cooling water circulating in the cooling circuit 4 is increased to about 120° C. The filter medium used in the filter 10 employs a heat-resistant material. A cooling medium is liquid, and the filter medium is prevented from serving as the source of contamination due to ion dissolution from the filter medium. In the ion dissolution from the filter medium, if ions are dissolved in the cooling water, the cooling circuit 4 is additionally provided with an ion exchange filter for removing such ions. If the temperature of the cooling water in the cooling circuit is decreased and dissolved ions are precipitated again as crystals, the ion exchange filter cannot remove such crystals. Materials for the filter medium of the filter 10 provided in the cooling circuit 4 are selected in consideration of such matters.

Requirements for the filter medium are as follows. Namely, the filter medium should remove fine impurities reliably and have the heat-resistance. Further, the filter medium should not cause the hydrogen brittleness and ion dissolution. In view of such requirements, a ceramic filter 20 to be described is employed as the filter medium.

FIG. 2 illustrates a schematic structure of the filter 10 employed in the circuits. The filter 10 is mainly formed of a casing 11 serving as a framework and the ceramic filter 20 placed in the casing 11. Holders 12 are provided in the casing 11. The ceramic filter 20 is supported by the holders 12.

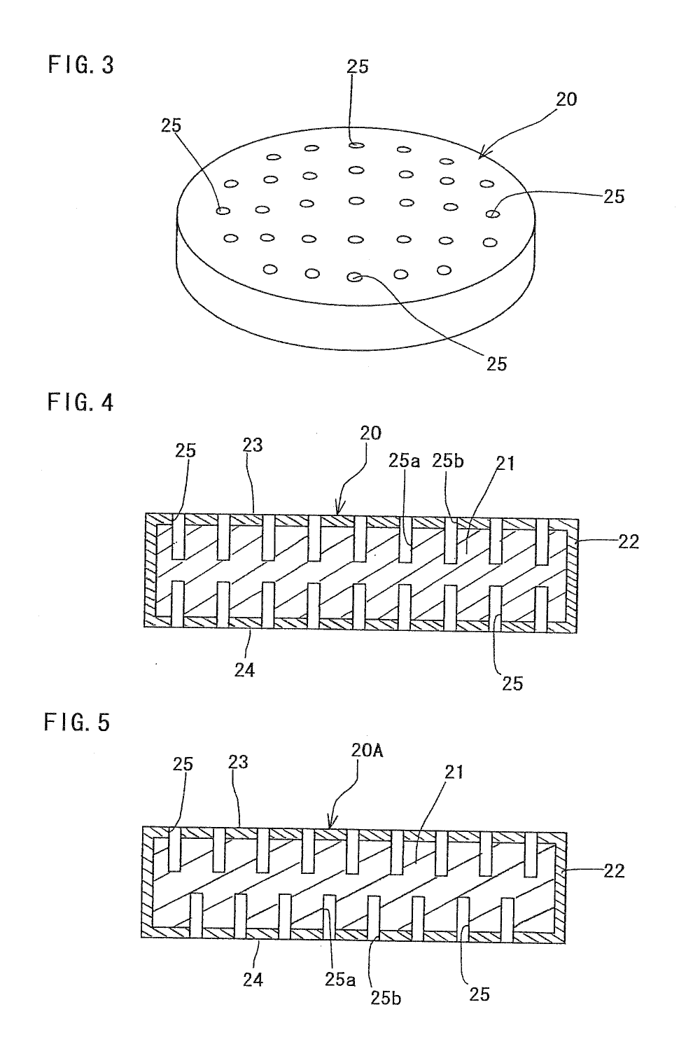

FIGS. 3 and 4 illustrate an example of the ceramic filter 20 employed in the filter 10. The ceramic filter 20 is formed in a disk with a certain thickness and provided with parallel flat sides. The ceramic filter 20 is formed of a ceramic mass 21 serving as the core and a coating material 22 coated on the surface of the ceramic mass 21. The ceramic mass 21 serving as the core has voids therein. Such voids are formed by heating the raw ceramic mass so as to burn contained carbon to be eliminated. The coating material 22 of a resin material coats the entire surface of the ceramic mass 21.

The coating material 22 is selected in view of the adhesion to the ceramic mass 21 serving as the core and the following capability with respect to the thermally expanded ceramic mass 21. Polypropylene, nylon, and fluorine are used for the coating material 22. The coating material 22 is not limited to such a resin material and epoxy, silicon, and rubber adhesives are used.

The ceramic filter 20 has a side in the thickness direction. This side serves as an inflow side 23 for a fluid to flow thereinto for filtering. The ceramic filter 20 has the other side opposing the one side. The other side serves as an outflow side 24 for the filtered fluid to flow out. The inflow side 23 and outflow side 24 have a plurality of holes 25 depressed internally from the surfaces, respectively. In the ceramic filter 20, the holes 25 formed in the inflow side 23 coincide in position with the holes 25 formed in the outflow side 24. The holes 25 formed in the inflow side 23 and outflow side 24 are serially arranged on the identical lines. The holes 25 are formed with a tool such as a drill with an outer diameter corresponding to the diameter of the holes 25 after the surface of the ceramic mass 21 is coated with the coating material 22. The position of a communication hole 25b in the coating material 22 coincides with the position of a hole 25a in the ceramic mass 21.

The plurality of holes 25 may be formed in the inflow side 23 and outflow side 24 in advance when the raw ceramic mass is formed. The holes 25 are masked not so as to be closed by the coating material 22 when the surface of the ceramic mass 21 is coated with the coating material 22. The masked portion functions as the communication hole 25b when removing the mask.

According to the ceramic filter 20, a fluid flows from the holes 25 on the inflow side 23 toward the inside of the ceramic filter 20. On the inflow side 23, the hole 25a of the ceramic mass 21 functions as an inflow portion for allowing the fluid to enter the ceramic mass 21. The communication hole 25b of the coating material 22 functions as a communicating portion for allowing the fluid which has flown in the circuit to enter the hole 25a of the ceramic mass 21. The fluid entering the ceramic mass 21 passes through the voids in the ceramic mass 21 to flow toward the holes 25 on the outflow side 24. Impurities contained in the fluid are thus filtered. The filtered fluid passes through the holes 25 on the outflow side 24 to flow out from the outflow side 24. The hole 25a formed in the ceramic mass 21 functions as an outflow portion on the outflow side 24. The communication hole 25b of the coating material 22 functions as a communicating portion for allowing the fluid to flow from the hole 25a of the ceramic mass 21 to the circuit.

According to the ceramic filter 20, the voids in the ceramic mass 21 serving as the core are formed by heating the raw ceramic mass so as to burn carbon contained therein and eliminate the same. Unlike ceramic masses prepared by compacting ceramic particles using binders, the ceramic filter does not employ such binders. If the fluid flows in the ceramic filter 20, dissolution of the binder does not occur. The ceramic filter 20 does not serve as the source of contamination.

However, articles on the surface of the ceramic mass 21 prepared as described above may be spilled, or the ceramic mass 21 may be chipped. To prevent such disadvantages, the entire surface of the ceramic mass 21 is coated with the coating material 22. If the ceramic mass 21 is coated with the coating material 22, the coating material 22 prevents the fluid from entering and exiting from the ceramic mass 21. The holes 25 on the inflow side 23 and outflow side 24 facilitate smooth inflow and outflow of the fluid. The holes 25 increase the area of contacting the fluid with the ceramic mass 21, thereby improving the filtration efficiency.

While the holes 25 are formed in the inflow side 23 and outflow side 24 so as to be arranged on the identical lines, they may be formed as illustrated in FIG. 5.

According to a ceramic filter 20A illustrated in FIG. 5, the position of the hole 25 formed on the inflow side 23 is displaced from the position of the hole 25 formed on the outflow side 24. When observing the cross section of the ceramic filter 20A, the holes 25 are arranged in a zigzag pattern in the diameter direction of the ceramic filter 20. The holes 25 on the top side are positioned between the holes 25 on the bottom side. The holes 25 on the bottom side are positioned between the holes 25 on the top side. According to the ceramic filter 20A illustrated in FIG. 5, the entire surface of the ceramic mass 21 serving as the core is coated with the coating material 22. The holes 25 on the inflow side 23 and outflow side 24 are formed with a tool such as a drill through the coating material 22.

The ceramic filter prepared by coating the entire surface of the ceramic mass with the coating material has been described. A ceramic filter prepared by coating the ceramic mass partially with the coating material may be employed.

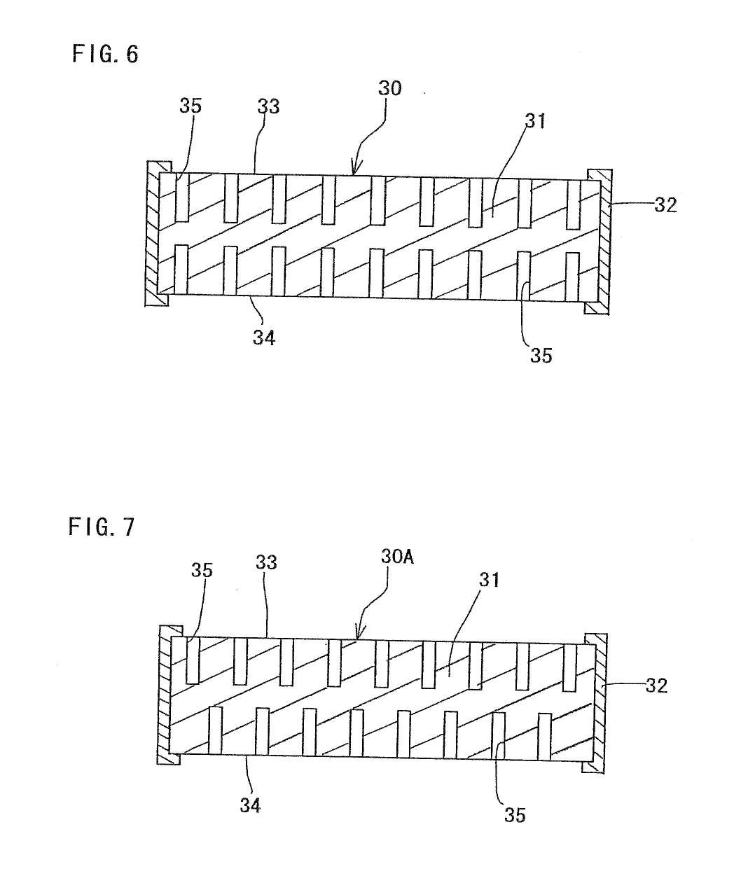

FIG. 6 is a cross-sectional view of a ceramic filter 30. A disk-shaped ceramic mass 31 with a certain thickness is employed for the ceramic filter 30. The circumferential surface of the ceramic mass 31 is coated with a coating material 32.

According to the ceramic filter 30, the ceramic mass 31 serving as the core has voids therein formed by heating the raw ceramic mass so as to burn contained carbon and eliminate the same. The ceramic mass 31 is provided with parallel flat sides. One side of the sides is an inflow side 33 that a fluid enters. The other side is an outflow side 34 having the fluid to exit therefrom. The inflow side 33 and outflow side 34 have a plurality of holes 35 depressed internally from the surfaces, respectively. According to the ceramic filter 30 illustrated in FIG. 6, the positions of the holes 35 on the inflow side 33 are the identical to those on the outflow side 34. Namely, the holes 35 on the inflow side 33 and the outflow side 34 are serially arranged on the identical lines. The holes 35 may be formed using a tool such as a drill or may be formed in advance when the raw ceramic mass 31 is formed.

The coating material 32 coats the circumferential surface of a portion between the inflow side 33 and outflow side 34 of the ceramic mass 31. The edges serving as boundaries between the circumferential surface and the inflow side 33 and between the circumferential surface and the outflow side 34 are easily chipped. To prevent such chipping, the coating material 32 extends further than the peripheries of the inflow side 33 and outflow side 34. Resin materials including polypropylene, nylon, and fluorine are employed for the coating material 32. The coating material 32 is not limited to such resin materials, and epoxy, silicon, and rubber adhesives are employed.

The ceramic filter 30 illustrated in FIG. 6 is mounted in the casing 11 of the filter 10 with its circumferential surface being held. The inflow side 33 and outflow side 34 of the ceramic filter 30 are not coated with the coating material 32, the area of contacting the fluid is increased. The contact area is further increased by the inner circumferential surfaces of holes 35 on the inflow side 33 and outflow side 34.

According to the ceramic filter 30 that the coating material 32 coats only the circumferential surface of the ceramic mass 31, as illustrated in FIG. 7, the holes 35 on the inflow side 33 may be displaced from those on the outflow side 34. FIG. 7 is a vertical cross-sectional view of a ceramic filter 30A. The holes 35 on the inflow side 33 and outflow side 34 are arranged in a zigzag pattern in the diameter direction of the ceramic filter 30A.

The ceramic filter having entire surface or circumferential surface coated with the coating material has been described by way of example. A ceramic filter whose surface is not coated with the coating material may be employed. When the ceramic filters described are employed for the filter 10 in the hydrogen feeding circuit 2, the aspiration circuit 3, and the cooling circuit 4, impurities with small particle diameters are filtered reliably. The temperature of the air in the aspiration circuit 3 is increased to about 160° C. The temperature of the cooling water in the cooling circuit 4 is increased to about 120° C. The ceramic filter has high heat-resistance, and the filtration efficiency is not decreased due to heat. The ceramic filter medium is not attacked by hydrogen, namely, does not cause hydrogen brittleness in the hydrogen feeding circuit 2. When the ceramic filter is provided in the cooling circuit 4, impurities with small particle diameters are filtered. The binder is not used, and the ceramic filter does not serve as the source of contamination.

While a case where the invention is applied to a circuit for a fuel cell using hydrogen as a fuel has been described above, the invention is not limited thereto and may also be applied to a circuit for a fuel cell using methane of a reducing material as a fuel. When hydrogen is used as a fuel, the invention may be applied to a circuit with a device for reforming natural gas or methanol to produce hydrogen.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

According to the invention, if the filter medium having an excellent heat resistance is used in the fuel cell system having a fluid of high temperatures to be filtered, the filter medium does not deteriorate due to heat. The ceramic mass being a core formed as the invention allows fine impurities to be efficiently filtered. Without using a binder, impurities contained in the binder do not dissolves, and the ceramic filter itself does not serves as a source of contamination.

Formation of holes on inflow side and outflow side of the filter medium enlarges contact area with a fluid, improving filtration efficiency. This enlargement of the contact area with the fluid due to the holes further widens efficient filtration portion if the filter medium is partially clogged.

Coating of the ceramic mass with a coating material effectively prevents disadvantage of the ceramic mass such as partial coming out and chipping.

What is claimed is:

1. A filter medium comprising:
a ceramic mass having a void formed by burning a contained carbon to be eliminated,
the ceramic mass having an inflow side for a fluid to flow thereinto and an outflow side for the fluid to flow out therefrom, the inflow side and the outflow side separate from each other with a distance,
the inflow side and the outflow side having holes depressed inward from the sides, respectively.

2. A filter medium comprising:
a ceramic mass having a void formed by burning a contained carbon to be eliminated,
the ceramic mass having an inflow side for a fluid to flow thereinto and an outflow side for the fluid to flow out therefrom, the inflow side and the outflow side separate from each other with a distance,
the ceramic mass having a surface having a circumferential surface between the inflow side and the outflow side, at least the circumferential surface being coated with a coating material.

3. A filter medium comprising:
a ceramic mass having a void formed by burning a contained carbon to be eliminated,
the ceramic mass having an inflow side for a fluid to flow thereinto and an outflow side for the fluid to flow out therefrom, the inflow side and the outflow side separate from each other with a distance,
the ceramic mass having a surface having a circumferential surface between the inflow side and the outflow side, at least the circumferential surface being coated with a coating material,
the inflow side and the outflow side having holes depressed inward from the sides, respectively.

4. The filter medium according to claim 3,
wherein the ceramic mass has an entire surface coated with a coating material,
wherein the coating material has communication holes coinciding with the holes of the inflow side and the outflow side,
wherein the communication holes extend through the coating material in a thickness direction of the coating material and communicate with outside of the ceramic mass.

5. A filtration system installed in a fluid path connected to a fuel cell for filtrating a fluid circulating through the fluid path by a filtration device,
the filtration device having a ceramic mass having a void formed by burning a contained carbon to be eliminated,
the ceramic mass having an inflow side for a fluid to flow thereinto and an outflow side for the fluid to flow out therefrom, the inflow side and the outflow side separating from each other with a distance,
the inflow side and the outflow side having holes depressed inward from the sides, respectively,
the filtration device being located downstream of a flow driver allowing the fluid to circulate through the fluid path.

6. A filtration system installed in a fluid path connected to a fuel cell for filtrating a fluid circulating through the fluid path by a filtration device,
the filtration device having a ceramic mass having a void formed by burning a contained carbon to be eliminated,
the ceramic mass having an inflow side for a fluid to flow thereinto and an outflow side for the fluid to flow out therefrom, the inflow side and the outflow side separating from each other with a distance,
the ceramic mass having a surface having a circumferential surface between the inflow side and the outflow side, at least the circumferential surface being coated with a coating material,
the filtration device being located downstream of a flow driver allowing the fluid to circulate through the fluid path.

7. A filtration system installed in a fluid path connected to a fuel cell for filtrating a fluid circulating through the fluid path by a filtration device,
the filtration device having a ceramic mass having a void formed by burning a contained carbon to be eliminated,
the ceramic mass having an inflow side for a fluid to flow thereinto and an outflow side for the fluid to flow out therefrom, the inflow side and the outflow side separating from each other with a distance,
the ceramic mass having a surface having a circumferential surface between the inflow side and the outflow side, at least the circumferential surface being coated with a coating material,
the inflow side and the outflow side having holes depressed inward from the sides, respectively,
the filtration device being located downstream of a flow driver allowing the fluid to circulate through the fluid path.

8. The filtration system according to claim 7,
wherein the ceramic mass has an entire surface coated with a coating material,
wherein the coating material has communication holes coinciding with the holes of the inflow side and the outflow side,
wherein the communication holes extend through the coating material in a thickness direction of the coating material and communicate with outside of the ceramic mass.
